(19) United States
(12) Patent Application Publication
(10) Pub. No.: US 2006/0011267 A1
(43) Pub. Date: Jan. 19, 2006

(54) Solder paste and process

(76) Inventors: Lawrence C. Kay, Los Angeles, CA (US); Terry L. Munson, Kokomo, IN (US); Erik J. Severin, Pasadena, CA (US)

Correspondence Address: CHRISTIE, PARKER & HALE, LLP, PO BOX 7068, PASADENA, CA, 91109-7068, US

(21) Appl. No.: 11/140,432

(22) Filed: May 27, 2005

Related U.S. Application Data
(60) Provisional application No. 60/575,563, filed on May 28, 2004.

(51) Int. Cl. B23K 35/34

(52) U.S. Cl. 148/23

(57) ABSTRACT

A solder paste comprises a lead-free solder powder, a flux and an active additive in the flux. The active additive comprises a material that scavenges metal oxide from molten solder, is a stable liquid at reflow soldering temperature, and has the ability to assimilate oxide of at least one metal in the solder. A preferred active additive is dimer acid present in the range of from 0.5 to 2.5% percent by weight of the paste. Sound joint are obtained when the paste is used in a reflow soldering process wherein the peak reflow temperature is preferably less than 245° C.

### CROSS REFERENCE TO RELATED APPLICATIONS

This application claims the benefit of the filing date of U.S. Provisional Application 60/575,563, filed May 28, 2004.

### FIELD OF THE INVENTION

This invention relates to a lead-free solder paste used for soldering of electronic equipment, and soldering processes for such lead-free solder paste.

### BACKGROUND

For decades electronic components or devices have been soldered to printed circuit (PC) boards with a lead-tin solder. A maximum soldering temperature of 260° C. (500° F.) has become a standard in the industry and this limit has propagated to many other parameters. For example, most components to be soldered to printed circuit boards are rated for a maximum temperature of 260° C. (500° F.). Continuous soldering apparatus is built to operate at a maximum temperature of about 260° C. Even the printed circuit (PC) boards (sometimes called printed wiring boards, PWB) are generally constructed for a maximum soldering temperature of about 260° C.

There is a desire to eliminate hazardous lead from solder, and there are even moves afoot to ban the use of lead. Exemplary substitute lead-free solder alloys include tin-silver and tin-silver-copper alloys having about 95-96.5% tin and 3.5-5% silver. Exemplary tin-silver base solder alloys sometimes have added alloying elements such as zinc, bismuth, antimony, germanium and/or indium. There has been difficulty in implementing some of such alloys because the temperatures required for reliable solder joints has exceeded 260° C. Thus, there is a need for tin-silver alloy solder paste that can be used at temperatures no more than 260° C. and preferably at temperatures not significantly higher than used for lead-tin solder.

Eutectic tin-lead solder (63% tin and 37% lead) is generally used for mounting of electronic parts on printed circuit boards by surface mount technology (SMT) or what is known as ball grid array (BGA). In SMT and BGA, one typically uses a solder paste (sometimes called cream solder) which comprises solder powder uniformly mixed with a soldering flux, most commonly a rosin flux with miscellaneous additives. The solder paste is applied to a printed circuit board by printing or dispensing (e.g. silk screen printing); a chip-type electronic part is temporarily secured on the board by adhesion of the solder paste; the entire printed circuit board is heated in a reflow oven to melt the solder, thereby securing the component to the printed circuit board and making electrical connections to the component.

In reflow soldering using solder paste, soldering is usually carried out in a heating furnace called a reflow furnace (or reflow oven), with two-stage or three-stage heating. There is first a preheating at a temperature of about 150-200° C. for 60-180 seconds. Preheating is below the melting point of the solder. The main heating is to a temperature about 20-40° C. higher than the melting point of the solder. In some cases there is a soaking time at a temperature below the melting point after the preheat and before ramping to the maximum temperature. Preheating vaporizes solvents (if any) in the solder paste and alleviates heat shock to electronic parts which have been mounted on a printed circuit board for soldering. Preheating, soaking and/or the main heating activate some parts of the solder flux to remove oxides from the surfaces to be soldered. The main heating forms the solder joints between components and/or the circuit board. After the highest temperature, there is controlled slow cooling. Cooling is slow enough to avoid thermal shock, but is preferably fast enough to minimize detrimental grain growth or formation of intermetallic compounds. The time above the melting point (TAL or time above liquid) is to be minimized to avoid damage to components on the board. The maximum temperature for reflow soldering is lower than tolerable in wave soldering, for example, since the components are exposed to high temperature for about a minute, whereas in wave soldering, the board is exposed to the solder wave for only a very few seconds at most.

The principal equipment used for reflow employs convective heating (or may combine with infra-red heating) for best temperature uniformity. Several heating zones are provided along a conveyor that carries PC boards through the reflow oven. Such equipment is suitable for SMT (surface-mount technology) or BGA (ball grid array) reflow. The atmosphere in the reflow oven may be air or nitrogen.

For lead-free solder, reflow soldering may have a maximum temperature of about 235° C. (455° F.), for example, although temperatures as high as 260° C. have been suggested for PC boards with large volume, thick components. The melting point of traditional lead-tin solder is about 183° C., whereas the most popular lead-free solders have melting temperatures around 217-218°. The significantly higher melting temperatures impose significantly different conditions for reflow with lead free solders. The acceptable bands of maximum temperature and TAL are narrowed. Fluxes are generally activated at higher temperatures and are formulated to be compatible with the lead-free alloy for adequate shelf life. Lead-free solder paste typically has higher surface tension than lead-tin solder paste, hence does not wet or spread on the printed surfaces as easily as the lead-tin solder pastes already known, hence higher temperatures have generally been required. Stencil designs may also need to be modified to compensate for the diminished spreading (or “slump”). Other than that, screen printing for lead-free paste is generally similar as for lead-tin solder paste. Slight changes may be appropriate for differences in solids loading in the lead-free paste.

In solder paste the solder is in the form of a powder (often balls) having a large surface area, and the effect of surface oxidation is marked. Furthermore, a soldering flux, which is mixed with the solder powder to form the solder paste, sometimes contains reactive components such as an activator, which may also cause oxidation of the solder powder and/or make the surface oxidation of solder powder more severe. Thus, when using tin-silver alloy solder paste there can be poor wettability of solder onto the substrate, and solder joints may have low strength, cracks, voids, and other defects. An improved solder paste with tin-silver-copper alloy or other lead-free solder is quite desirable.

Such a solder paste should have viscosity suitable for application by existing equipment and be capable of forming sound solder joints at reflow temperatures no more than 260° C. and preferably as low as 235° C. by reflow processes generally similar to tradtional lead-tin alloy reflow processes, or at least using conventional reflow ovens.

### BRIEF SUMMARY OF THE INVENTION

In practice of this invention, an active additive is included in a solder paste having flux and lead-free alloy solder powder. The active additive is preferably a dimer acid added to a tin-silver-copper alloy solder paste.

### DESCRIPTION

This invention addresses the important issue of purity or cleanliness of lead-free solder in a reflow paste. It has been discovered that scavenging metal oxide from molten solder is of great importance in producing reliable and reproducible solder joints. This is of particular importance when using lead-free solder alloys. An active additive introduced into the flux in a solder paste is used to scavenge and assimilate metal oxide. This has the surprising result of reliable lead-free solder joints produced at a peak reflow temperature no more than the 260° C. limit for electronic components and often at temperatures as low as 235° C.

The improved soldering paste process is useful with a variety of lead-free solder alloys. Such alloys are based on tin and the most popular alloys are tin-silver-copper alloys. Exemplary alloys include Sn₉₆/Ag₄; Sn_{96.5}/Ag_{3.5}; Sn_{93.6}/Ag_{4.7}/Cu_{1.7}; Sn_{95.2}/Ag₄/Cu_{0.8}; Sn_{95.2}/Ag_{3.9}/Cu_{0.9}; Sn_{95.2}/Ag_{3.8}/Cu₁; Sn_{95.5}/Ag_{3.8}/Cu₁; Sn_{96.2}/Ag₃/Cu_{0.7}; Sn_{96.5}/Ag₃/Cu_{0.5}; Sn_{96.2}/Ag_{2.5}/Cu_{0.8}/Sb_{0.5}; and Sn_{99.3}/Cu_{0.7}. These are currently the most popular alloys and other lead-free alloys are known or may be developed. The preferred soldering alloys are the tin-silver-copper alloys.

It will be recognized that these examples are of the alloy powder before melting and that when a joint is made with such alloys there may be changes in composition as metal is picked up from the substrate (e.g. increased copper content). It will also be recognized that these are nominal compositions and some variation in composition is present within commercial tolerance ranges. Since these alloys have differences in melting ranges, there will likewise be differences in processing times and temperatures, and in the composition of preferred flux for a paste. No differences have been found for action of the active additive, although not all possible alloy variations have been investigated.

The active additive in a solder paste comprises a material that scavenges metal oxide from the molten metal, has the ability to assimilate oxide of at least one solder-metal (e.g. tin), is compatible with flux ingredients, and is stable at the reflow soldering temperature. The active additive should remain liquid in the reflow process for a commercially acceptable time. Typically, the active additive material comprises an organic molecule with nuleophilic and/or electrophilic end groups. Carboxylic end groups, such as in a dimer acid, are particularly preferred.

In its simplest form in one embodiment, dimer acid is included in a solder paste with flux and tin-silver-copper alloy solder powder. The dimer acid may substitute for some of the flux instead of being added to flux used in a solder paste composition. A viscous liquid dimer acid is preferred for control of viscosity of the paste during application to a circuit board and upon preheating. It is found that as little as one percent dimer acid (relative to total paste weight) is sufficient for improving solderability.

A dimer acid is a high molecular weight di-carboxylic acid which is liquid (typically viscous at room temperature), stable and resistant to high temperatures. It is produced by dimerization of unsaturated or saturated fatty acids at mid-molecule and often contains 36 carbons. (For example, a trimer acid which contains three carboxyl groups and 54 carbons is analogous. A trimer of shorter fatty acid chains with about 36 total carbons would be equivalent.) Fatty acids are composed of a chain of aliphatic groups containing from 4 to as many as 30 carbon atoms (although commercially useful fatty acids have up to 22 carbon atoms) and characterized by a terminal carboxyl group, —COOH. The generic formula for all carboxylic acids above acetic acid is CH₃(CH₂)ₓCOOH. The carbon atom count includes the —COOH group.

Fatty acids may be saturated or unsaturated. In some cases there may be dimers of mixed saturated and unsaturated fatty acids. Exemplary saturated fatty acids include palmitic acid (C16) and stearic acid (C18). Unsaturated fatty acids are usually vegetable-derived and comprise aliphatic chains usually containing 16, 18 or 20 carbon atoms with the characteristic end group —COOH. Among the most common unsaturated acids are oleic acid, linoleic acid and linolenic acid, all C18. Saturated fatty acids are preferred in practice of this invention. They are more stable at elevated temperature than unsaturated fatty acids with appreciable double bonds. Aromatic fatty acids are also known, for example phenyl-stearic, abietic acid and other fatty acids derived from rosin. Rosin acids comprise C20 monomers and may contain a phenanthrene ring (e.g. abietic and pimaric acids). Dimers containing phenyl rings are quite acceptable when the rings are linked (if more than one is in a molecule) solely at one corner so that the molecule has “flexibility”. Phenyl rings are effectively flat and may stack to form a monomolecular film on molten solder. The aromatic dimer acids may also be more thermally stable than similar carbon number aliphatic dimer acids.

The dimers (and higher oligomers) of fatty acids may be dimers of like fatty acids or copolymers of different fatty acids. This can be seen from the mass spectrometer analysis of composition of an exemplary commercial grade of “dimer acid” found useful in practice of this invention. As set forth in Tables I to III, the “dimer acid” was found to be about 89% dimer, about 6% monomer (fatty acids) and 5% trimer acid.

The commercially available monomeric fatty acids used to make dimers can vary appreciably depending on the source of raw materials. The proportions of different acids present differs as between coconut oil, peanut oil, palm oil, olive oil, corn oil, safflower oil, tung oil, rapeseed oil, tall oil, distilled tall oil, oils from marine sources, etc. Such oils may be blended for still further variations.

The dimerized molecules may have considerable variation due to source of fatty acid and/or polymerizing parameters. For example, one might consider a dimer as an X-shaped structure of four aliphatic chains with primary hetero atoms or reactive end groups on one or more of the chains. There may be various lengths of all four chains depending on where the source materials linked. The typical two —COOH end groups on a dimer acid may be on the ends of adjacent chains or on the ends of opposite chains. The hetero atoms at the ends of chains may be the same or different, and although two is typical, there may be one or more active end groups on individual molecules.

Instead of a neat X such as might be found in an 8,9-substituted C18 alkane, the side chains on a C18 chain might not be directly opposite, but may be found at essentially any location along such a chain. (For example, side chains might be at positions 3 and 12, or 3 and 9, or almost any other combination.) The hetero atoms may be essentially along the length of such a chain instead of at the end of a carbon chain. Also, not all molecules in a mixture need to be the same and probably never are.

Thus, a broad variety of dimers, trimers and higher polymers can be made depending on the raw material monomers and the polymerization conditions and/or catalyst. For example, just one manufacturer of commercial “dimer acids” offers about two dozen different grades, and there are numerous manufacturers annually producing about 235 million pounds of such products. Many of these dimer acids include varying proportions of monomer, dimer and trimer. Most are made from tall oil feedstocks, but other fatty acid sources are also prevalent.

Commercially available dimer acids may have mixed dimers, i.e., dimers where the two fatty acids are different from each other, and there may be mixes of saturated and unsaturated fatty acids which are dimerized. Since dimerization occurs at a site of unsaturation, starting with unsaturated fatty acids may result in the preferred saturated dimers.

Exemplary commercially available dimer acids and trimer acids include AVER13, AVER17, AVER18 and AVER19 available from Aver Chemical, Yuanda Group of Yichun City, JiangXi Province, China; Century 1156, Unidyme 11, Unidyme 14, Unidyme 14R, Unidyme 18, Unidyme 22, Unidyme 27, Unidyme 35, Unidyme 40, Unidyme 60, Unidyme M-9, Unidyme M-15, Unidyme M-35, Unidyme T-17, Unidyme T-18, and Unidyme T-22 available from Arizona Chemical Company of Dover, Ohio and Picayune, Miss.; Empol 1008, Empol 1018, Empol 1022, Empol 1040 and Empol 1062 available from Cognis Group of Cincinnati, Ohio and Kankakee, Ill.; Meadwestvaco DTC 155, DTC 175, DTC 180, DTC 195, DTC 275, DTC 295, DTC 595, and SCTO available from MeadWestvaco of Stamford, Conn.; a dimer acid identified as PM200 which is 80 to 90% dimer acid, 10 to 20% trimer acid and a maximum of 5% monomer acid available from Samwoo Oil Chemical Co of Yangjugun, KYE, Korea; products from Resolution Performance Products, Lakeland, Fla.; Pripol 1006, Pripol 1009, Pripol 1013, Pripol 1017 and Pripol 2033 available from Uniqema of London, England and Wilmington, Del.; Empol 1010, Empol 1014, Empol 1016, Empol 1018, Empol 1022, Empol 1024, Empol 1040, and Empol 1041 available from Brown Chemical Co. (distributor) of Paterson, N.J.; Pacific Dimer Acid from Pacific Epoxy Polymers, Inc., of Richmond, Mo.; and various dimer acid products from Lianyou Products of Hianjin, China; Kodia Company Limited of Changsha, China; and Zhejiang Yongzai Chemical Industry Co. of Zhejiang, China. This list is not believed to be comprehensive and other dimer acids and the like may be commercially available from these or other vendors.

In addition to dicarboxylic dimer acids, nucleophilic or electrophilic substitutions for the —COOH group, per se, may also be equivalent. Some acceptable end groups might not be considered to be electrophilic or nucleophilic in strictest chemical terms but are still capable of complexing or forming non-covalent (e.g. dative) bonds with metal oxides. For purposes of this application such end groups are considered within the scope of “nucleophilic and/or electrophilic”. For example, other additives comprise amines, alcohols, thiols, phosphenes, and amides, as dimers and/or trimers. Other additives may be suitable if they do not disassociate at the temperature of the molten solder bath comprise esters, anhydrides, imides, lactones and lactams. (For example, ERISYS GS-120, a glycidyl ester of linoleic acid dimer, available from Specialty Chemicals Inc. of Moorestown, N.J.)

Thus, the active additive may comprise the hydrocarbon moiety of a dimer and/or trimer of fatty acid and at least one nucleophilic or electrophilic group on the hydrocarbon moiety. It is preferable that there are at least two nucleophilic or electrophilic groups and more specifically that the groups are carboxylic.

For practice of this invention, it is considered that dimers and/or trimers of fatty acids having at least eight carbon atoms (C8) can be used. Instead of a dimer of fatty acid with about 18 carbon atoms, a trimer of a lower molecular weight fatty acid may have properties sufficiently similar to a dimer acid to be used as an additive in lead-free solder paste.

The active additive need not always have a hydrocarbon moiety corresponding to a dimer of fatty acid. In other words, an appropriate additive is an organic molecule with a hydrocarbon moiety, and functional group(s) which are nucleophilic or electrophilic to capture tin oxide and/or other oxide of a solder metal. For example, a long chain hydrocarbon (preferably saturated) split near one end with a side chain and nucleophilic or electrophilic groups on one or both ends of the split is acceptable.

There are properties of the active additive that are important for commercial applications. For example, the additive in the milieu of flux is liquid at the temperature of molten solder, and has sufficient stability against oxidation to not degrade the shelf life of the solder paste. The active additive includes an organic material having one or more nucleophilic and/or electrophilic end groups and has the ability to scavenge and assimilate oxide of at least one metal in the solder. It is also desirable that the additive be non-corrosive, non-conductive and non-hydrophilic so that there is no detriment in the event of residue of additive on a PC board or other object soldered, and there is little or no need for supplemental cleaning. If cleaning is desirable, the active additive should be removable with the same cleaning process used for flux.

Since the number of commercially available dimer acids and/or trimer acids and other suitable nucleophilic containing molecules is quite large and the number of possibilities within the scope of this broad terminology is even larger, there is some probability that there are substances which will not work as described, and therefore not be suitable for practice of this invention. For example, a dictionary definition of fatty acid goes down to 4 carbon atoms in the monomer. A dimer of this material would probably be inappropriate for any of a number of reasons. For example, it may not be a good film former; it may have a vapor pressure that is too high (or boiling point that is too low), so that it would not be suitable in a solder paste; it may have a flash point that is too low for use at 260° C.; etc.

For practice of this invention, it is considered that dimers and/or trimers of fatty acids having at least eight carbon atoms (C8) can be used.

Dimer acids and trimer acids effective in a soldering process can be made from fatty acids having about 18 carbon atoms, including the carbon in the carboxyl group. Readily available fatty acids from vegetable sources generally have an even number of carbon atoms. A number of C18 fatty acid monomers are mentioned above. An example of a C16 fatty acid monomer is palmitic acid. Since they are easily available and inexpensive, dimer acids and/or trimer acids are preferred with carbon numbers ranging from about C16 to C22. Dimer and/or trimer acids with higher carbon numbers are probably suitable for some soldering applications but are not readily commercially available. When the carbon number is lower than about twelve, it is believed desirable to employ trimers or higher polymers or dendrimers to achieve adequate carbon moiety lengths.

As noted above, dimer acid and/or trimer acid suitable for use in practice of this invention is not necessarily pure dimer of one fatty acid. An example has been given of a dimer acid which includes small amounts of monomer and trimer. What could be termed a “trimer acid” having a substantial proportion of trimer of fatty acids, may be suitable. Thus, for example, a trimer acid having about two-thirds trimer and one-third dimer may be quite satisfactory, particularly if the fatty acid(s) used to make the trimer have small carbon numbers.

Fortunately, it is quick, easy and inexpensive to screen candidate dimer acid and/or trimer acid or other material of types mentioned herein to avoid those that are unsuitable. Clearly, one skilled in the art can eliminate some substances by simply knowing some of the physical properties, such as viscosity, vapor pressure, boiling point, flash point, etc. Some candidate substances may remain, where it is uncertain whether they will work well. Those can be found by a screening test. One simply formulates a solder paste with a candidate material, applies it to circuit board in a conventional manner and runs the board through a reflow furnace. Just a few test boards are enough to tell whether a material is suitable. A screening test may be performed on “bare” boards without mounted components. A pattern of spots or lines of conductive material (e.g. copper) is formed on the test board. A pattern of solder paste is printed onto such conductive ares and the board is heated in an exemplary reflow cycle. The wetting of solder on the processed board can be observed to determine if the putative additive is suitable. Compositions passing such screening may be tested with prototype boards having SMT or BGA components mounted. Such test boards are conventionally processed whenever the operator comtemplates new boards, components, materials or reflow processes.

A surprising effect of active additive in other processes is a reduction in viscosity of the molten metal, and the same effect is believed present during reflow of solder paste. There appears to be solubility or at least dispersion of metal oxide in molten metal, such as dispersion of tin oxide in tin. (The solubility of oxygen in tin, for example, is very low.) It only takes a small amount of metal oxide to change the rheology of molten metal. Even a small concentration of high melting point materials in the molten metal may raise the viscosity of the metal. An active additive appears to scavenge and assimilate at least some of the metal oxide dispersed in the molten solder, thereby purifying or cleansing the solder, and lowering the viscosity of the molten metal. Oxide in the metal may also interfere with wetting of the solid metal surfaces.

The solder paste includes a flux. The function of a flux in soldering is to remove the oxide film from the solid metal substrate by reacting with or otherwise loosening that film from the surface. The molten flux then forms a protective blanket which prevents re-formation of the oxide film until molten solder displaces the flux and reacts with the base metal to form an intermetallic bond. In a solder paste the finely divided solder powder has a considerable surface area which can become oxidized. The flux reacts with that oxide as well. An active additive is included in the flux of this invention to assimilate or sequester oxide from the molten solder, whether originally on the surface of the solder powder or dispersed within the solder. By assimilating the oxide, interference with wetting is minimized. Surprisingly, use of an active additive promotes wetting at a given temperature, so that soldering of printed circuit boards may be accomplished at a lower temperature than without the active additive.

Wetting balance tests show the effectiveness of an active additive which scavenges oxides from the metal on wetting of lead-free solder on copper. In a wetting balance test, a test coupon is lowered into molten solder and allowed to wet the metal surface before withdrawing the coupon from the bath.

In the tests described herein, about 4.5 kg. of SAC 305 alloy was in a pot with a surface area of about 310 sq cm. This alloy has 3% silver, 0.5% copper and balance tin. Test coupons were like pieces of PC board with copper on one face. A test coupon is 1.27 cm wide and was immersed in the solder 2.54 cm. All test coupons were “fresh” with a conventional OSP (oxygen solder protection) sealer on the surface. The OSP sealer inhibits oxidation of the copper before soldering. Shortly before immersion, a Type R flux was applied on the copper surface. (The type R flux is a conventional flux, about 25% by weight water-white gum rosin and balance isopropyl alcohol. It evaporates or “burns off” rapidly at soldering temperatures.) The solder in the pot was quiescent (i.e., there was no flow). Before a sample coupon was immersed, a flat blade was used to push visible dross and/or additive away from the area where the coupon was to be immersed.

In a pair of tests, coupons were immersed in SAC 305 alloy solder at 235° C., and in neither case was there any wetting after eight seconds in the solder pot. One coupon had slight wetting after about eight seconds. In effect, this was non-wetting. (235° C. is a typical temperature for solder reflow with conventional lead-tin solder alloy.)

Coupons were also immersed at 245, 255 and 265° C., respectively. The coupon immersed at 245° showed retarded poor wetting (after about four seconds). The coupon at 255° showed slow poor wetting (after about 1.5 seconds). The coupon at 265° showed good wetting (at less than ¾ second). There was no additive on the bath during these tests.

About two fluid ounces (about 60 ml) of dimer acid was added to the solder pot and allowed to spread to the edges. When pushed away with a blade, about ⅓ of the surface of the molten solder had a layer of dimer acid with a thickness estimated as about ¼ inch (about 6 mm). No visible dimer acid was in the region where the coupons were immersed. There was no visible dross on the surface. Three test coupons were immersed and in each test there was good wetting at 235° C. Each sample reached the zero force axis at about 0.3 seconds and was fully wetted in no more than ¾ second.

After dimer acid was apparently cleaned from the pot and dross was allowed to form, coupons showed significantly retarded wetting at 235° C. There was no wetting before about two seconds on any of three coupons. Reasonable wetting was found after about four seconds.

Because of enhanced wetting at temperatures similar to those used for lead-tin solder, the use of active additive permits reflow soldering with lead-free solder at these lower temperataures despite the significantly higher melting point of the lead-free alloys. Nickel-gold alloy substrates commonly used on PC boards are resistant to wetting by lead-free solder, particularly at lower temperatures. Use of active additive in solder paste promotes wetting of such alloy surfaces all the way to the edge of conductive pads, whereas wetting to the edge of pads is unusual without an active additive. Complete wetting is desirable in the event rework is needed on such a board. This is in addition to the enhanced wetting indicating a sound joint.

Rosin in a flux is essentially “used up” during reflow processing. This is believed to occur before the solder powder has melted or at least before the metal has coalesced. Thus, there is potential for oxidation of solder metal surfaces before the substrate has been wetted. The active additive is, however, more stable than the rosin at soldering temperatures and remains as a “blanket” to minimize oxidation as well as assimilate any oxides that may form or already be present on or in the solder.

Remarkably, the appearance of a lead-free solder joint surface may be changed by using an active additive in solder paste. A good quality conventional solder joint of lead-tin alloy has a smooth shiny surface, and operators doing soldering rely on that appearance to assess whether there are good joints. There are even automated optical inspection machines for quality control of soldered PC boards. However, the surface of a lead-free solder such as a tin-silver-copper alloy is typically rather rough looking or grainy (sometimes described as “gritty”), even when an acceptable joint has been produced. There may also be what seem to be flow lines or patches of ordered irregularities on the surface (sometimes referred to as looking “wrinkled”). These are subjective observations of the joint appearance which are not quantified, but are apparent to an experienced operator either with the naked eye or with small magnification.

Surprisingly, it has been found that the surface of a lead-free solder joint formed from a melt where active additive is present generally has the smooth (non-textured) shiny appearance of a conventional lead-tin solder joint. Thus, visual inspection may be useful for quality control of lead-free solder joints when active additive has been used in the processing.

These visual observations of the surface of solder joints with and without use of active additive in the process are “averages”. In other words, an observation of one joint may not clearly indicate whether a joint was made with or without active additive. An individual joint may be ambiguous, although other times even a single joint is enough to distinguish processes with and without active additive. When a group of joints made by one process are examined, use or non-use of active additive can be distinguished.

Solder paste manufacturers and vendors employ a variety of proprietary mixtures of ingredients in the flux. Among the organic ingredients available and often used include water white rosin, glutamic acid, citric acid, aniline hydrochloride, aniline phosphate, hydrazine hydrobromide, lactic acid, olieic acid, stearic acid, urea, abietic acid, phthalic acid, ethylene diamine, naphthalene, dehydro abietic acid, leviopmaric acid, naphthalene tetrachloride and naphthalene tetrabromide. Metal salts (e.g. copper stearate) and halides (e.g. ammonium chloride) are sometimes used. Inorganic acids are used in flux for many soldering applications, but are rarely present in solder paste, particularly where the paste is used for electronics applications. Vehicles for the flux include water, glycerine, petroleum jelly, methylated spirit, isopropyl alcohol, polyethylene glycol, and turpentine, sometimes supplemented with wetting agents or metal soaps. The organic acids are used as mild activators. Active additive is not known to be inactivated or inhibited by any usable flux ingredient, nor do active additives degrade the shelf life of solder paste with such fluxes. No significant changes in viscosity or separation has been found with any flux actually tested.

Although called an “active additive”, the new material is not an “activator” as that term is used in flux compositions. An activator is a material that decomposes or otherwise changes upon heating to an activation temperature to produce a by-product that reacts with oxide on the substrate. For example, an activator may produce ammonia or hydrochloric acid in an RA or even an RMA flux.

Solder paste flux lowers the surface tension of solder to improve capillary flow and optimizes fillet geometries by promoting wetting, and protects surfaces from reoxidation during reflow. Rosin-base flux is preferred. Since pure-rosin (water-white) flux is a very weak acid, its residues are not corrosive in most applications. Sometimes the activity of the rosin-base flux is enhanced by addition of activators and these fluxes are designated as mildly activated (RMA), fully activated (RA) and super-activated (RSA). Non-activated rosin based flux is designated as type R.

Type R flux containing only rosin is the least active and is recommended for surfaces very clean to start with. It leaves virually no residue behind. Rype RMA contains a small amount of additional activator and. leaves only a minimum amount of inert residue behind. A characteristic of RMA flux is that the remaining residue is noncorrosive, tack free and exhibits a high degree of freedom from ionic contamination after cleaning. RMA and RA flux residues should be removed from printed circuit boards, and RSA residues must be removed since they are corrosive in electronics applications. The activators typically used often have halide ions to increase activity, however, there are also halide-free activated fluxes suitable for use in the paste.

The solder paste may also include conventional Theological or thixotropic components such as thickeners and solvents. The solder particle shape, size distribution and concentration, along with the binder properties determine the flow characteristics of the paste, both during application to a substrate and during the reflow process. The adhesive or binder properties are a consequence of the flux composition, active additive, thickeners (if any) and solvents.

No more than insignificant amounts of residue of active additive appear to remain on PC boards after reflow. However, if cleaning is desired, cleaning of PC boards after reflow may be with deionized water or mild organic solvents. Benign solvents for cleaning flux residues exist, such as iso-propyl alcohol and aqueous solutions containing surfactants, for example. These are also appropriate for removing any active additive residue. Toluene is effective for dissolving and removing dimer acid, which is a presently preferred active additive. A combination of polar and non-polar solvents may be used for dissolving and removing both rosin and ionic activators. Water based cleaning may use a biodegradable cleaner cpable of saponifying rosin to form a soluble soap while ionics dissolve in the water.

It is quite desirable to use “no-clean” or low-solids flux for which residues do not pose any corrosion concern after soldering. Inorganic acid fluxes are highly corrosive and not considered suitable. Organic acid fluxes which are water soluble may be used for soldering to substrates difficult to wet with non-activated rosin fluxes, and care should be used to remove residues which may be corrosive.

It is believed that oxidation requires nucleation sites to form oxides that would interfere with soldering. By assimilating most of the oxide and isolating it from locations where oxide interferes, nucleation sites are reduced and oxide formation is likewise reduced. What oxide does form is captured by the surface active additive and removed from harm's way. Furthermore, the carboxylic acid groups on the dimer acid combine with metal oxides to sequester the metal and release harmless water vapor. Thus, some of the metal oxides that form in or on lead-free solder are eliminated and good surface wetting and good solder joints are obtained.

It is particularly surprising that use of dimer acid in a tin-silver base solder paste enables reflow soldering to be conducted at a lower temperature. The tin-silver eutectic (at 3.5% silver) is at 221° C. The reflow temperature is above the eutectic temperature and above the melting point of tin (232° C.). A tin-silver alloy solder paste can be reflowed at less than 260° C. A tin-silver-copper alloy solder is preferred since these alloys have a lower reflow temperature and excellent wetting. The melting point of the tin-silver-copper alloys is about 217-218° C. and minimum flow temperatures specified by manufacturers are generally about 235° C. It is preferred that the peak reflow temperature for lead-free solder paste with active additive is less than 245° C. The failure rate of electronic components or devices when temperatures are as high as 245° C. can become excessive. The general rule is that TAL should be as short as possible and peak reflow temperature should be as low as possible, while still obtaining sound solder joints. Use of an active additive in the solder paste helps achieve those objectives.

Peak reflow temperature is a temperature measured by a thermocouple placed on a test PC board run through a reflow oven. The board is representative of boards to be processed in the reflow oven and not all such boards are instrumented. A number of thermocouples (sometimes eight or more) are placed in appropriate locations on the board and attached to a thermal process monitor that records the the temperatures of each thermocouple as the board is passed through the reflow oven. The peak reflow temperature sought is the maximum temperature recorded at any of these thermocouples. The appropriate location for a thermocouple is adjacent or attached to the leads (SMT components) or balls (BGA components) or beneath components of large thermal mass. It is desirable that the thermocouple be soldered adjacent to a lead, although other attachments may be used so long as the attachment does not interfere with accurate temperature measurement. Component body temperature may also be monitored by some thermocouples. An appropriate location for a thermocouple for a BGA device is adjacent the center ball location. This can be by drilling through from the bottom side of the board and inserting a thermocouple through the hole. Lead or ball temperatures are monitored to assure good solder joints and component body temperatures are measured to protect the devices.

It is possible that active additives with nucleophilic or electrophilic end groups are forming “heavy metal soaps” in the heat of the molten solder alloy. These soaps are structures where the carboxyl group is complexed to a metal ion, for example, tin, at an end of an aliphatic chain, for example. When carboxylic end groups are present, tin may substitute for hydrogen in the —COOH group (two such groups for divalent tin). An exemplary reaction is
(R—COOH)₂+SnO═(R—COO)₂Sn
where (R—COOH)₂ represents the dimer acid. When tin has a valence of four as in SnO₂ the product is (R—COO)₄Sn by combination of two dimers with the tin oxide. Tin oxides that form during reflow are most likely divalent because of the short time exposure to oxygen at elevated temperature. The valence of oxide in the solder powder is unknown. Like most salts, these heavy metal soaps have a high heat tolerance which may explain why the additives do not rapidly degrade in the harsh environment of reflow soldering.

Thus, an aspect of this invention is reducing viscosity and/or surface tension of a molten solder by adding a dimer and/or trimer with nucleophilic end group(s) to the solder paste. A preferred nucleophilic end group is —COOH. The additive is believed to reduce the amount of oxide on the solder and improve wettability. By reducing viscosity and/or surface tension in this manner, lower reflow temperatures can be used.

The solder paste is adjusted to obtain viscosity suitable for its method of application to a substrate (printed circuit board, for example). The paste is typically deposited by screen printing, stencil printing or bulk dispensing (or painting) techniques and viscosity suitable for these techniques can be easily adjusted by those skilled in the art. For example, smaller size solder particles are used for stencil or screen printing to pass through the small holes in the screen or stencil, particularly for fine pitch PC boards. The viscosity is also adjusted to be suitable for the desired thickness of paste on the board. That thickness may range from about 0.08 mm to 0.25 mm depending on the pitch of the adjacent areas of solder. If viscosity is too high, paste passes through the screen or stencil with difficulty and there may be “skips” in the printing. On the other hand, if the viscosity is too low, the paste may flow too much laterally from the holes and/or may slump and spread beyond the desired pattern.

The paste is also made sufficiently tacky to hold components on the board before the reflow cycle. There are well know tests for tackiness, slump and viscosity and those skilled in the art can readily formulate binders, and hence solder paste, that pass these tests.

Exemplary thixotropic agents are hardened castor oil, amides, waxes and the like. Some examples of solvents are carbitols such as butylcarbitol and hexylcarbitol, and alcohols such as terpineol and halogenated alcohols. Short carbon chain dimers and fatty acid monomers may also be used as somewhat active solvents, permitting reduction in the quantity of flux activator in the paste. Solvents should have relatively low vapor pressure to prolong the shelf life of the paste after the jar is opened. The amount of solvent is appropriate for the desired viscosity.

It is not believed that there are firm limits on the amount of the above components in the solder paste binder, but typically, the rosin is approximately 35-70 weight percent, activator is up to approximately 10% (if used), and thixotropic agents are approximately 1 to 10%. Solvents and additives (such as surfactants) make up the rest of the composition.

Active additive is preferably present in the range of from about 5 to 25% weight percent of the flux phase of the paste mixture. Relative to the total weight of the solder paste, the active additive is preferably present in the range of from about 0.5 to 2.5%, although larger amounts are also believed suitable. Amounts smaller than about 0.5% have reduced effectiveness in promoting wetting. Larger amounts of active additive may replace too much of the other ingredients of the flux phase of the paste mixture, so that there is inadequate fluxing action. Larger amounts of active additive may also leave undesirable quantities of residue on finished boards.

Suitable solder alloys for practice of this invention include tin-silver and tin-silver-copper alloys having about 95% to essentially pure tin and up to about 5% silver. Exemplary tin-silver base solder alloys sometimes have added alloying elements such as zinc, bismuth, antimony, and/or germanium. Such additional alloying elements may take the proportions of tin and silver outside the above mentioned ranges. Low proportions of alloying elements may be present for reflow of essentially pure tin rather than tin-silver alloy. A small amount of other element such as copper or silver is included in the pure tin to inhibit growth of tin whiskers.

There is no particular limitation on the form of the lead-free solder alloy powder, but normally it is a spherical powder. The powder can be prepared by the centrifugal atomizing method or the gas atomizing method or other conventional method. The particle size of the solder powder may be the same as for a conventional lead-tin solder paste and is usually on the order of 200-400 mesh, but powder which is 500 mesh or finer may also be used. (Finer particles have more surface for oxidation. Finer particles may also be desirable for fine pitch printing.) Typically, the binder is about 5 to 20 percent by weight of the paste and the remainder is solder powder. Because of the density difference, the binder may comprise up to half of the volume of the paste, for example. The proportion of solvent in the binder, and proportions of binder and solder powder are readily adjusted to achieve the desired viscosity and tackiness of the paste for printing on a board.

By using a solder paste of tin-silver base solder alloy according to the present invention, oxidation of the solder surface is effectively minimized. It appears that viscosity or surface tension of the molten solder is reduced, enhancing wetability of solder onto components and substrates. Furthermore, the active additive in the solder paste enables reflow soldering with tin-silver alloy solder to be conducted at temperatures no more than 260° C. Surprisingly, by use of active additive in the solder paste, lead-free reflow soldering may be performed at temperatures as low as the usual temperatures used for lead-tin alloy solder. This is a huge benefit. Accordingly, the solder paste of the present invention facilitates lead-free soldering by a reflow method and contributes to minimizing lead pollution.

TABLE I
Monomeric fatty acids, relative and absolute amounts

| Monomers | % of monomers | Amount in sample |
|---|---|---|
| Stearic | 48% | 2.9% |
| Oleic | 43% | 2.6% |
| Linoleic | 9% | 0.5% |
| Total | 100% | 6% |

TABLE II
Dimeric fatty acids, relative and absolute amounts

| Dimers | % of dimers | Amount in sample |
|---|---|---|
| oleic-stearic | 3% | 2.7% |
| oleic-oleic | 18% | 16.0% |
| linoleic-oleic | 46% | 40.9% |
| linoleic-linoleic; linolenic-oleic | 14% | 12.5 |
| linolenic-linoleic | 9% | 8.0 |
| linolenic-linolenic | 8% | 7.1 |
| mass 276-linolenic | 3% | 2.7% |
| Total | 101% | 90% |

TABLE III
Trimeric fatty acids, relative and absolute amounts

| Trimers | % of trimers | Amount in sample |
|---|---|---|
| oleic-oleic-oleic | 14% | 0.7% |
| oleic-oleic-linoleic | 46% | 2.3% |
| oleic-linoleic-linoleic | 26% | 1.3% |
| linoleic-linoleic-linoleic | 13% | 0.7 |
| Total | 99% | 5% |

What is claimed is:

1. A solder paste comprising:
a lead-free solder powder;
a flux;
an active additive in the flux, the active additive comprising a material that scavenges metal oxide from molten solder, is a stable liquid at reflow soldering temperature, and has the ability to assimilate oxide of at least one metal in the solder.

2. A solder paste according to claim 1 wherein the active additive comprises an organic molecule with nuleophilic and/or electrophilic end groups.

3. A solder paste according to claim 2 wherein the end groups comprise carboxylic end groups.

4. A solder paste according to claim 1 wherein the active additive comprises dimer acid.

5. A solder paste according to claim 4 wherein the dimer acid is present in the range of from 0.5 to 2.5% percent by weight of the paste.

6. A solder paste according to claim 1 wherein the active additive is present in the range of from 0.5 to 2.5% percent by weight of the paste.

7. A solder paste according to claim 1 wherein the lead-free solder powder comprises a tin-silver base alloy.

8. A solder paste according to claim 7 wherein the lead-free solder powder comprises a tin-silver-copper alloy.

9. A solder paste comprising:
a tin-silver-copper solder alloy powder;
a flux; and
a dimer acid mixed with the flux.

10. A solder paste according to claim 9 wherein the dimer acid is present in the range of from 0.5 to 2.5% percent by weight of the paste.

11. A solder paste according to claim 9 wherein the dimer acid is present in the range of from 5 to 25% percent by weight of the flux phase of the paste mixture.

12. A reflow soldering process comprising:
forming a solder paste comprising a lead-free solder powder, flux and an active additive in the flux, the active additive comprising a material that scavenges metal oxide from molten solder, is a stable liquid at a reflow soldering temperature, and has the ability to assimilate oxide of at least one metal in the solder;
applying the solder paste to a substrate to be soldered;
applying at least one component to the substrate; and
forming a solder joint between the substrate and electrical leads on the component by reflow heating of the substrate, component and solder paste.

13. A reflow soldering process according to claim 12 wherein the active additive is present in the range of from 0.5 to 2.5% percent by weight of the paste.

14. A reflow soldering process according to claim 12 wherein the active additive comprises a dimer acid.

15. A reflow soldering process according to claim 14 wherein the dimer acid is present in the range of from 5 to 25% percent by weight of the flux phase of the paste mixture.

16. A reflow soldering process according to claim 12 wherein the peak reflow temperature is no more than 260° C.

17. A reflow soldering process according to claim 12 wherein the peak reflow temperature is less than 245° C.

18. A reflow soldering process according to claim 12 wherein the lead-free solder powder comprises a tin-silver base alloy.

19. A reflow soldering process according to claim 16 wherein the lead-free solder powder comprises a tin-silver-copper alloy.

20. A solder joint made the process of claim 12 wherein the peak reflow temperature is no more than 260° C.

21. A solder joint made the process of claim 12 wherein the peak reflow temperature is less than 245° C.
